(19) United States
(12) Patent Application Publication
(10) Pub. No.: US 2012/0165027 A1
(43) Pub. Date: Jun. 28, 2012

(54) COMMUNICATION SYSTEM INCLUDING FEMTO BASE STATION

(75) Inventors: Jun Sik KIM, Seoul (KR); Kyong Tak CHO, Daejeon (KR); Sang Chul OH, Daejeon (KR); Hyung Deug BAE, Daejeon (KR); Seung Que LEE, Daejeon (KR); Nam Hoon PARK, Daejeon (KR)

(73) Assignee: Electronics and Telecommunications Research Institute, Daejeon (KR)

(21) Appl. No.: 13/330,604

(22) Filed: Dec. 19, 2011

(30) Foreign Application Priority Data
Dec. 22, 2010 (KR) 10-2010-0132890

(51) Int. Cl. H04W 40/00

(52) U.S. Cl. 455/446

(57) ABSTRACT

Provided is a terminal to transmit wireless environment measurement information to a femto base station, and the femto base station to receive the wireless environment measurement information from the terminal. The femto base station may perform initialization based on the wireless environment measurement information, or may transmit the wireless environment measurement information to a base station control unit. The base station control unit may determine whether to additionally install a second femto base station based on the wireless environment measurement information.

### CROSS-REFERENCE TO RELATED APPLICATION

This application claims the priority benefit of Korean Patent Application No. 10-2010-0132890, filed on Dec. 22, 2010, in the Korean Intellectual Property Office, the disclosure of which is incorporated herein by reference.

### BACKGROUND

1. Field of the Invention

Embodiments of the present invention relate to a communication system, more particularly, to a communication system including a femto base station.

2. Description of the Related Art

A femto base station corresponds to a small base station having coverage of about 10 m to 20 m. The femto base station may be installed indoors such as a home, an office, and the like, to decrease load of an existing network.

Since the femto base station may be installed as per request of users rather than a systematic design of providers, the femto base station may be installed at an arbitrary position for user convenience, rather than an optimal position based on a network environment. Accordingly, there is a desire for technology capable of installing the femto base station at the optimal position based on a wireless environment.

In addition, the femto base station may select an operational mode from among a plurality modes including an open mode in which all of users are allowed for an access, a closed mode in which only a predetermined user is allowed for the access, and a mixed mode in which all of the users are allowed for the access and a radio resource is priorly assigned to the predetermined user. Interference against a neighboring base station may be different based on each operational mode. Accordingly, there is a desire for technology capable of determining the operational mode of the femto base station based on the varying affect of interference.

### SUMMARY

An objective of the present invention is to enhance the quality of service (QoS) of a wireless communication system using wireless environment measurement information around a femto base station.

Another objective of the present invention is to determine an appropriate installation position of a femto base station.

According to an aspect of the present invention, there is provided a femto base station, including: a receiver to receive wireless environment measurement information from a terminal. An operational mode of the femto base station may be determined based on the wireless environment measurement information, among a plurality of modes including an open mode in which all of terminals are allowed to access the femto base station, a closed mode in which only an allowed terminal is allowed to access the femto base station, and a mixed mode in which all of the terminals are allowed to access the femto base station and a radio resource is priorly assigned to a predetermined terminal.

The terminal may be installed within the femto base station.

The wireless environment measurement information may be a received signal strength of a pilot signal that is received by the terminal from the femto base station, or a signal to interference plus noise ratio (SINR) of the pilot signal.

The femto base station may further include a display unit to display the wireless environment measurement information. An installation position of the femto base station may be adjusted based on the displayed wireless environment measurement information.

The femto base station may further include a transmitter to transmit the wireless environment measurement information to a base station control unit. A second femto base station may be installed based on the wireless environment measurement information.

According to another aspect of the present invention, there is provided a terminal, including: a receiver to receive a pilot signal from a femto base station; a wireless environment measuring unit to generate wireless environment measurement information using the pilot signal; and a transmitter to transmit the wireless environment measurement information to the femto base station. An operational mode of the femto base station may be determined based on the wireless environment measurement information, among a plurality of modes including an open mode in which all of terminals are allowed to access the femto base station, a closed mode in which only an allowed terminal is allowed to access the femto base station, and a mixed mode in which all of the terminals are allowed to access the femto base station and a radio resource is priorly assigned to a predetermined terminal.

The terminal may be installed within the femto base station.

The wireless environment measurement information may be a received signal strength of the pilot signal or an SINR of the pilot signal.

The wireless environment measurement information may be used as an initial setting parameter of the femto base station.

According to still another aspect of the present invention, there is provided a femto base station, including: a receiver to receive wireless environment measurement information from a terminal; and a setting unit to perform an initial setting of the femto base station based on the wireless environment measurement information.

The terminal may be installed within the femto base station.

The wireless environment measurement information may be a received signal strength of a pilot signal that is received by the terminal from the femto base station, or an SINR of the pilot signal.

An operational mode of the femto base station may be determined based on the wireless environment measurement information among a plurality of modes including an open mode in which all of terminals are allowed to access the femto base station, a closed mode in which only an allowed terminal is allowed to access the femto base station, and a mixed mode in which all of the terminals are allowed to access the femto base station and a radio resource is priorly assigned to a predetermined terminal.

The femto base station may further include a controller to calculate the affect of interference according to each mode based on the wireless environment measurement information. The operational mode may be determined based on the computed affect of interference.

The femto base station may further include a transmitter to transmit the wireless environment measurement information to a base station control unit. A second femto base station may be installed based on the wireless environment measurement information.

### EFFECT

According to embodiments of the present invention, it is possible to enhance the quality of service (QoS) of a wireless communication system using wireless environment measurement information around a femto base station.

Also, according to embodiments of the present invention, it is possible to determine an appropriate installation position of a femto base station.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a concept of wireless environment measurement information of a femto base station system according to an embodiment of the present invention;

FIG. 2 is a diagram illustrating an interference circumstance around a femto base station according to an embodiment of the present invention;

FIG. 3 is a diagram illustrating an example of switching an operational mode of a femto base station according to an embodiment of the present invention;

FIG. 4 is a flowchart illustrating a process of determining an operational mode of a femto base station according to an embodiment of the present invention;

FIG. 5 is a block diagram illustrating a configuration of a femto base station according to an embodiment of the present invention;

FIG. 6 is a block diagram illustrating a configuration of a terminal according to an embodiment of the present invention; and

FIG. 7 is a block diagram illustrating a configuration of a femto base station according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

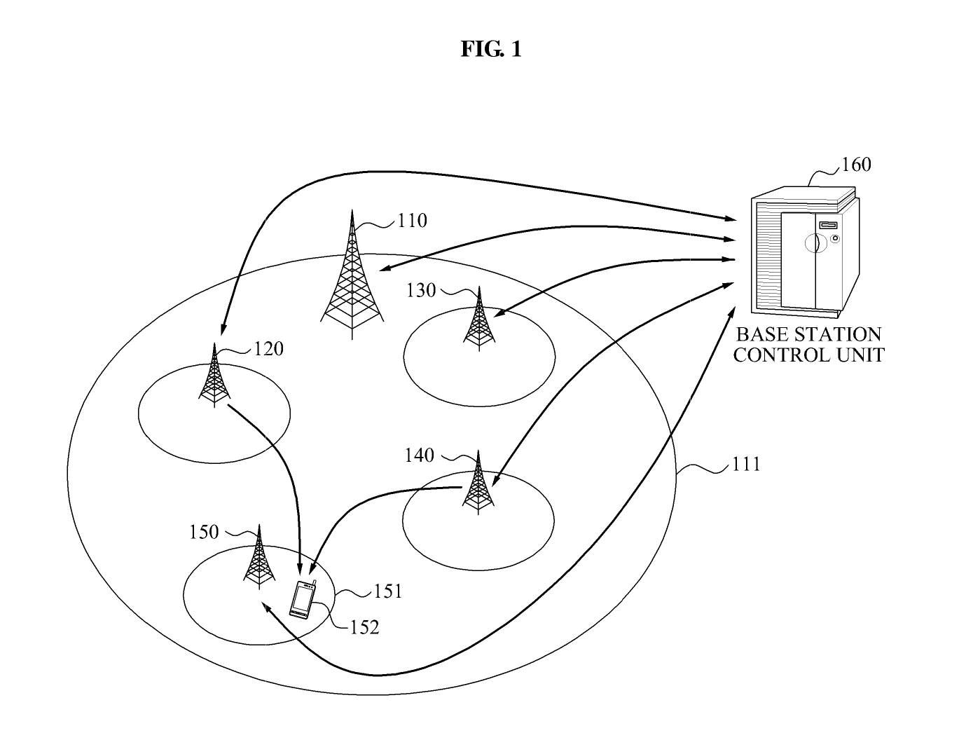

FIG. 1 is a diagram illustrating a concept of wireless environment measurement information of a femto base station system according to an embodiment of the present invention. Referring to FIG. 1, femto base stations 120, 130, 140, and 150 may be positioned within coverage 111 of a macro base station 110 to transmit data to a terminal 152 that is positioned within coverage 151 of the femto base station 150, or to receive data from the terminal 152. The macro base station 110 may assign radio resources to be used by the femto base stations 120, 130, 140, and 150. A base station control unit 160 may control each of the femto base stations 120, 130, 140, and 150 to determine a corresponding operational mode, and the like.

When the femto base station 150 is newly installed, the femto base station 150 may generate wireless environment measurement information including information about interference from other femto base stations 120, 130, and 140, and may transmit the generated wireless environment measurement information to the macro base station 110. The macro base station 110 may reassign radio resources to the femto base station 150 based on the wireless environment measurement information.

The femto base station 150 may transmit the wireless environment measurement information to the base station control unit 160. The base station control unit 160 may determine the operational mode of the femto base station 150 based on the wireless environment measurement information.

The femto base station 150 may display the wireless environment measurement information for a user. The user may determine whether the femto base station 150 is currently installed at an optimal position, based on the displayed wireless environment measurement information. The user may determine again an installation position of the femto base station 150 based on the wireless environment measurement information.

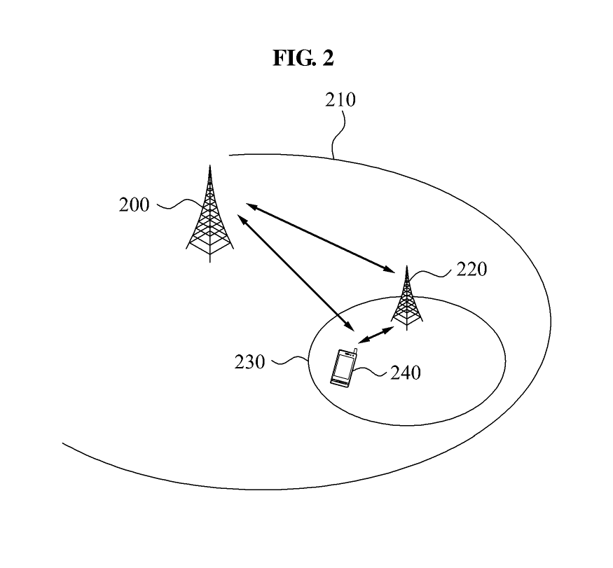

FIG. 2 is a diagram illustrating an interference circumstance around a femto base station 220 according to an embodiment of the present invention.

A terminal 240 may be included in coverage 210 of a macro base station 200 and coverage 230 of the femto base station 220. When the femto base station 220 operates in a closed mode, and when the terminal 240 does not have a right to access the femto base station 220, the terminal 240 may need to access the macro base station 200.

A distance between the macro base station 200 and the terminal 240 may be further away than a distance between the femto base station 220 and the terminal 240. Accordingly, the terminal 240 may transmit data with a significantly great amount of transmission power. The data transmitted from the terminal 240 may act as a strong interference signal in the femto base station 220.

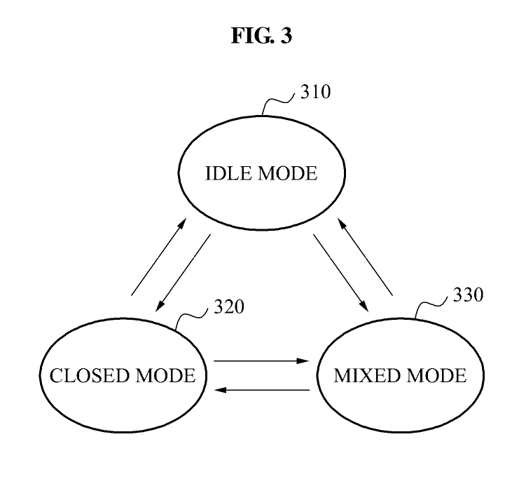

FIG. 3 is a diagram illustrating an example of switching an operational mode of a femto base station according to an embodiment of the present invention.

The femto base station may operate in one of a plurality of modes shown in FIG. 3. The femto base station may be shifted from a closed mode 320 to a mixed mode 330 in response to an instruction of a base station control unit or a macro base station.

In an open mode, all of terminals are allowed to access the femto base station. In the closed mode 320, only a terminal included in a predetermined terminal group is allowed to access the femto base station. In the closed mode 320, the femto base station may assign an identifier to the terminal included in the terminal group, and may allow only the terminal assigned with the identifier to access the femto base station.

In the mixed mode 330, the femto base station may allow all of terminals to access the femto base station and may priorly allow a radio resource with respect to the terminal included in the predetermined terminal group or may priorly provide a service thereto.

Based on the operational mode of the femto base station, the affect of interference against the macro base station or other femto base stations may be different. For example, when the femto base station operates in the closed mode 320 as shown in FIG. 2, the affect of interference against the macro base station or other femto base stations may be great. However, when the femto base station operates in the open mode or the mixed mode 330, the terminal may access the femto base station to thereby transmit data. Accordingly, the transmission power of the terminal may be significantly small. Accordingly, the affect of interference against the macro base station or other femto base stations may be significantly small.

The femto base station may be initialized in an idle mode 310 to thereby operate in the closed mode 320. The femto base station may be shifted to the mixed mode 330 based on wireless environment measurement information. For example, when the affect of interference against the macro base station or other base femto base stations is great, the femto base station may operate in the mixed mode 330 or the open mode.

When there is no terminal accessing the femto base station in the closed mode 320 or the mixed mode 330, the femto base station may be shifted to the idle mode 310. In the idle mode 310, the femto base station may transmit only broadcasting information and wait for the terminal to access the femto base station. In the idle mode 310, the femto base station may transmit broadcasting information at an interval further longer than a broadcasting information transmission interval in the closed mode 320 or the mixed mode 330.

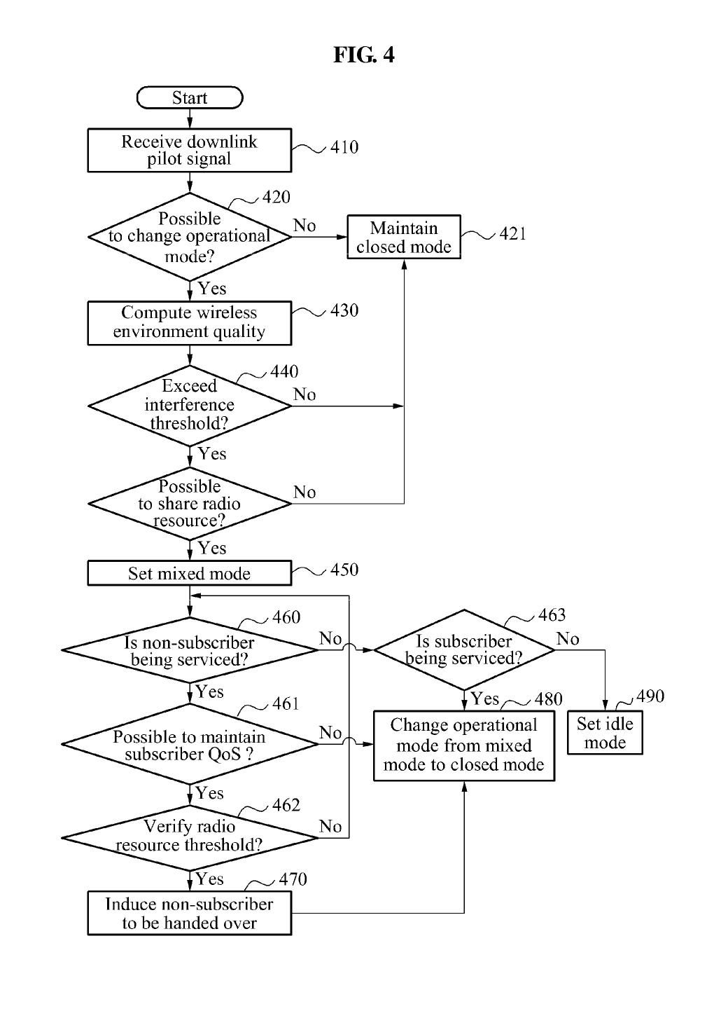

FIG. 4 is a flowchart illustrating a process of determining an operational mode of a femto base station according to an embodiment of the present invention.

In operation 410, the femto base station may receive a downlink pilot signal of a macro base station. In operation 410, the femto base station may operate in a closed mode.

In operation 420, the femto base station may determine whether to change an operational mode. When it is impossible to change the operational mode, the femto base station may maintain the closed mode in operation 421.

On the contrary, when it is possible to change the operational mode, the femto base station may compute a wireless environment quality within coverage in operation 430. The femto base station may receive wireless environment measurement information from a terminal and may compute the wireless environment quality based on the wireless environment measurement information. The wireless environment measurement information may be a received signal strength of a pilot signal that is received by the terminal from a second femto base station installed adjacent to the femto base station, or a signal to interference plus noise ratio (SINR) of a pilot signal that is transmitted from the femto base station. Alternatively, the wireless environment measurement information may be an amount of interference within coverage.

In operation 440, the femto base station may determine whether the amount of interference with coverage exceeds an interference threshold. When the amount of interference does not exceed the interference threshold, the femto base station may maintain the closed mode in operation 421.

On the contrary, when the amount of interference exceeds the interference threshold, the femto base station may determine whether it is possible to share a radio resource in operation 441. The femto base station may determine whether a current radio resource can satisfy a service required by all of terminals within coverage and also be shared. When it is impossible to share the radio resource, the femto base station may maintain the closed mode in operation 421.

On the contrary, when it is possible to share the radio resource, the femto base station may determine the operational mode as a mixed mode in operations 450.

In operation 460, the femto base station may verify whether a general terminal, not the terminal included in the predetermined terminal group, is being serviced. When the general terminal is serviced, the femto base station may determine whether it is possible to maintain QoS in operation 461. When it is possible to maintain the QoS, the femto base station may verify a threshold of radio resources assigned to the femto base station in operation 462. When there is a future possibility to exceed the threshold of radio resources, the femto base station may induce the general terminal to be handed over in operation 470. In operation 480, the femto base station may change the operational mode from the mixed mode to the closed mode.

On the contrary, when it is impossible to maintain the QoS in operation 461, the femto base station may change the operational mode from the mixed mode to the closed mode in operation 480.

Also, when there is no general service being serviced in operation 460, the femto base station may determine again whether a terminal included in the predetermined terminal group is being serviced. When the terminal included in the predetermined terminal group is being serviced, the femto base station may change the operational mode form the mixed mode to the closed mode in operation 480.

On the contrary, when no terminal included in the predetermined terminal group is being serviced, the femto base station may change the operational mode to the idle mode in operation 490.

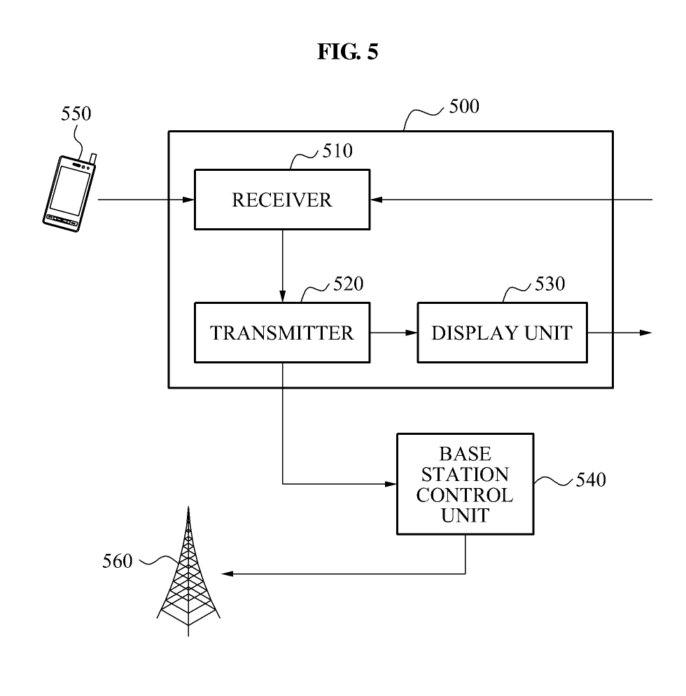

FIG. 5 is a block diagram illustrating a configuration of a femto base station 500 according to an embodiment of the present invention.

The femto base station 500 may include a receiver 510, a transmitter 520, and a display unit 530.

The receiver 510 may receive wireless environment measurement information from a terminal 550. The terminal 550 may be a terminal that is positioned within coverage of the femto base station 500, to measure the affect of an interference signal from another femto base station or a macro base station to report the measured affect to the femto base station 500.

The terminal 550 may be installed within the femto base station 500 as a portion of the femto base station 500. Also, the wireless environment measurement information measured by the terminal 550 may be a received signal strength of a pilot signal that is received by the terminal 500 from a second femto base station 560 adjacent to the femto base station 500, or an SINR of a pilot signal that is transmitted from the femto base station 500.

The transmitter 520 may transmit the wireless environment measurement information to a base station control unit 540. The base station control unit 540 may determine an operational mode of the femto base station 500 based on the wireless environment measurement information. The base station control unit 540 may determine, as the operational mode of the femto base station 500, one of an open mode in which all of terminals are allowed to access the femto base station 500, a closed mode in which only terminals that are included in a predetermined terminal group and have a right to access the femto base station 500 are allowed to access the femto base station 500 and other terminals are not allowed to access the femto base station 500, and a mixed mode in which all of terminals are allowed to access the femto base station 500 and terminals included in the predetermined terminal group are priorly allowed.

The display unit 530 may display the wireless environment measurement information. The display unit 530 may compute the wireless environment quality based on the wireless environment measurement information. For example, the display unit 530 may compute the wireless environment quality based on the received signal strength of the pilot signal that is received by the terminal 500 from a second femto base station 560 adjacent to the femto base station 500, and the SINR of the pilot signal that is received from the femto base station 500.

The display unit 530 may display the computed wireless environment quality for a user. The user may determine whether a current position of the femto base station 500 is optimal based on the wireless environment quality. When the current position of the femto base station 500 is not optimal, the user may determine again an installation position of the femto base station 500. That is, the installation position of the femto base station 500 may be determined again based on the wireless environment measurement information.

The transmitter 520 may transmit the wireless environment measurement information to the base station control unit 540. The base station control unit 540 may determine whether the femto base station 500 is capable of providing a sufficient service based on the wireless environment measurement information. When a terminal positioned within coverage of the femto base station 500 transmits a robust interference signal to the macro base station or the other femto base station, the base station control unit 540 may determine that the femto base station 500 is not providing a sufficient service. In this case, the base station control unit 540 may determine that the second femto base station 560 is to be installed around the femto base station 500.

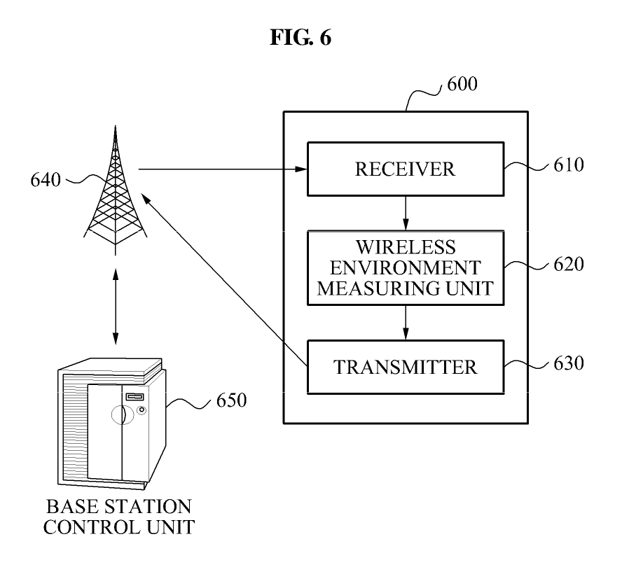

FIG. 6 is a block diagram illustrating a configuration of a terminal 600 according to an embodiment of the present invention.

The terminal 600 may include a receiver 610, a wireless environment measuring unit 620, and a transmitter 630.

The receiver 610 may receive a pilot signal from a femto base station 640. Also, the receiver 610 may receive a second pilot signal from a second femto base station positioned around the femto base station 640.

The wireless environment measuring unit 620 may generate wireless environment measurement information using the pilot signal received from the femto base station 640 and the second pilot signal received from the second femto base station. The wireless environment measurement information may be a received signal strength of the second pilot signal that is received by the terminal 600 from the second femto base station, or an SINR of the pilot signal that is received by the terminal 600 from the femto base station 640.

The transmitter 630 may transmit wireless environment measurement information to the femto base station 640. The femto base station 640 may transmit wireless environment measurement information to a base station control unit 650. The base station control unit 650 may determine an operational mode of the femto base station 640 based on the wireless environment measurement information. The base station control unit 650 may determine, as the operational mode of the femto base station 640, one of an open mode in which all of terminals are allowed to access the femto base station 640, a closed mode in which only terminals that are included in a predetermined terminal group and have a right to access the femto base station 640 are allowed to access the femto base station 640 and other terminals are not allowed to access the femto base station 640, and a mixed mode in which all of terminals are allowed to access the femto base station 640 and terminals included in the predetermined terminal group are priorly allowed.

When the femto base station 640 changes the operational mode, or when the femto base station 640 is initially installed, an initial setting may be performed by employing the wireless environment measurement information as an initial setting parameter.

Even though the femto base station 640 and the terminal 600 appear to be separate from each other in FIG. 6, the terminal 600 may be installed within the femto base station 640 depending on embodiments. The terminal 600 may accurately determine the wireless environment at a position where the femto base station 640 is positioned, and the femto base station 640 may determine the operational mode based on the wireless environment measured by the terminal 600.

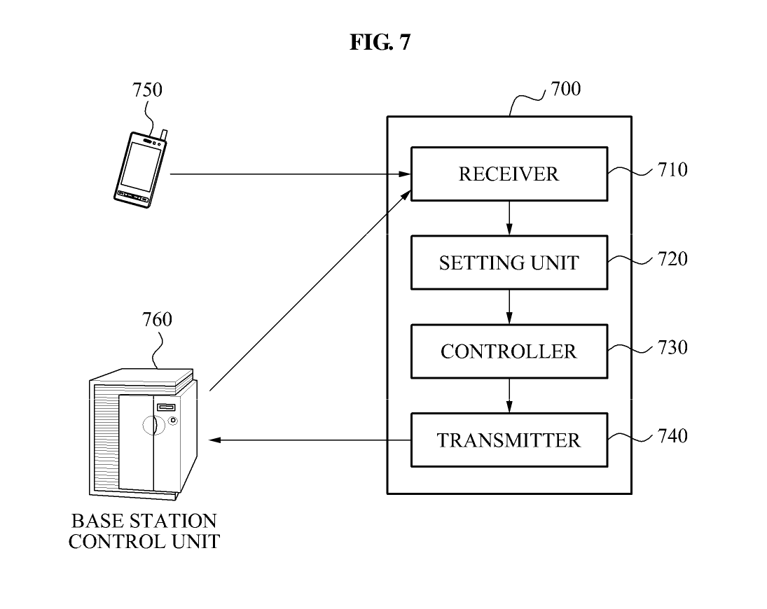

FIG. 7 is a block diagram illustrating a configuration of a femto base station 700 according to another embodiment of the present invention.

The femto base station 700 may include a receiver 710, a setting unit 720, a controller 730, and a transmitter 740.

The receiver 710 may receive wireless environment measurement information from a terminal 750. The terminal 750 may be a terminal that is positioned within coverage of the femto base station 700, to measure the affect of an interference signal from another femto base station or a macro base station and to report the measured affect to the femto base station 700. Even though the femto base station 700 and the terminal 750 appear to be separate from each other in FIG. 7, the terminal 750 may be installed within the femto base station 700 depending on embodiments.

The wireless environment measurement information measured by the terminal 750 may be a received signal strength of a pilot signal that is received by the terminal 750 from a second femto base station positioned around the femto base station 700, or an SINR of a pilot signal that is transmitted from the femto base station 700.

The setting unit 720 may perform an initial setting of the femto base station 700 based on the wireless environment measurement information.

The transmitter 740 may transmit wireless environment measurement information to a base station control unit 760. The base station control unit 760 may determine an operational mode of the femto base station 700 based on the wireless environment measurement information. The base station control unit 760 may determine, as the operational mode of the femto base station 700, one of an open mode in which all of terminals are allowed to access the femto base station 700, a closed mode in which only terminals that are included in a predetermined terminal group and have a right to access the femto base station 700 are allowed to access the femto base station 700 and other terminals are not allowed to access the femto base station 700, and a mixed mode in which all of terminals are allowed to access the femto base station 700 and terminals included in the predetermined terminal group are priorly allowed.

The controller 730 may compute the affect of interference according to each mode based on wireless environment measurement information. The transmitter 740 may transmit the computed affect to the base station control unit 760. The base station control unit 760 may determine the operational mode of the femto base station 700 based on the received affect of interference.

The transmitter 740 may transmit the wireless environment measurement information to the base station control unit 760. The base station control unit 760 may determine whether the femto base station 700 is capable of providing a sufficient service based on the wireless environment measurement information. When a terminal positioned within coverage of the femto base station 700 transmits a robust interference signal to the macro base station or the other femto base station, the base station control unit 760 may determine that the femto base station 700 is not providing a sufficient service. In this case, the base station control unit 760 may determine that a second femto base station is to be installed around the femto base station 700.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A femto base station, comprising:
a receiver to receive wireless environment measurement information from a terminal,
wherein an operational mode of the femto base station is determined based on the wireless environment measurement information, among a plurality of modes comprising an open mode in which all of terminals are allowed to access the femto base station, a closed mode in which only an allowed terminal is allowed to access the femto base station, and a mixed mode in which all of the terminals are allowed to access the femto base station and a radio resource is priorly assigned to a predetermined terminal.

2. The femto base station of claim 1, wherein the terminal is installed within the femto base station.

3. The femto base station of claim 1, wherein the wireless environment measurement information is a received signal strength of a pilot signal that is received by the terminal from the femto base station, or a signal to interference plus noise ratio (SINR) of the pilot signal.

4. The femto base station of claim 1, further comprising:
a display unit to display the wireless environment measurement information,
wherein an installation position of the femto base station is adjusted based on the displayed wireless environment measurement information.

5. The femto base station of claim 1, further comprising:
a transmitter to transmit the wireless environment measurement information to a base station control unit,
wherein a second femto base station is installed based on the wireless environment measurement information.

6. A terminal, comprising:
a receiver to receive a pilot signal from a femto base station;
a wireless environment measuring unit to generate wireless environment measurement information using the pilot signal; and
a transmitter to transmit the wireless environment measurement information to the femto base station,
wherein an operational mode of the femto base station is determined based on the wireless environment measurement information, among a plurality of modes comprising an open mode in which all of terminals are allowed to access the femto base station, a closed mode in which only an allowed terminal is allowed to access the femto base station, and a mixed mode in which all of the terminals are allowed to access the femto base station and a radio resource is priorly assigned to a predetermined terminal.

7. The terminal of claim 6, wherein the terminal is installed within the femto base station.

8. The terminal of claim 6, wherein the wireless environment measurement information is a received signal strength of the pilot signal or a signal to interference plus noise ratio (SINR) of the pilot signal.

9. The terminal of claim 6, wherein the wireless environment measurement information is used as an initial setting parameter of the femto base station.

10. A femto base station, comprising:
a receiver to receive wireless environment measurement information from a terminal; and
a setting unit to perform an initial setting of the femto base station based on the wireless environment measurement information.

11. The femto base station of claim 10, wherein the terminal is installed within the femto base station.

12. The femto base station of claim 10, wherein the wireless environment measurement information is a received signal strength of a pilot signal that is received by the terminal from the femto base station, or a signal to interference plus noise ratio (SINR) of the pilot signal.

13. The femto base station of claim 10, wherein an operational mode of the femto base station is determined based on the wireless environment measurement information among a plurality of modes comprising an open mode in which all of terminals are allowed to access the femto base station, a closed mode in which only an allowed terminal is allowed to access the femto base station, and a mixed mode in which all of the terminals are allowed to access the femto base station and a radio resource is priorly assigned to a predetermined terminal.

14. The femto base station of claim 13, further comprising:
a controller to calculate the affect of interference according to each mode based on the wireless environment measurement information,
wherein the operational mode is determined based on the computed affect of interference.

15. The femto base station of claim 10, further comprising:
a transmitter to transmit the wireless environment measurement information to a base station control unit,
wherein a second femto base station is installed based on the wireless environment measurement information.
